(19) United States
(12) Patent Application Publication
(10) Pub. No.: US 2026/0201929 A1
(43) Pub. Date: Jul. 16, 2026

(54) MUD CONTROL DEVICE FOR VEHICLE TIRE

(71) Applicants: Eric Paradis, Peace River (CA); David Wilkinson, Celista (CA)

(72) Inventors: Eric Paradis, Peace River (CA); David Wilkinson, Celista (CA)

(21) Appl. No.: 19/022,311

(22) Filed: Jan. 15, 2025

(51) Int. Cl. F16D 55/00

(52) U.S. Cl. CPC F16D 55/00; F16D 2055/0037

(57) ABSTRACT

A mud control device that is operably coupled adjacent a brake system component of a vehicle within the vehicle wheel wherein the mud control device substantially inhibits mud and debris from contacting the brake calipers and pads of the vehicle. The mud control device includes a center portion that is planar in manner having a first end and a second end. The center portion includes a first longitudinal edge that is arcuate in form. Opposite the first longitudinal edge is the second longitudinal edge which is straight in form and configured to be placed adjacent the inner surface of a vehicle wheel. The center portion has a first lateral member contiguously formed therewith at the first end of the center portion being perpendicular therewith. A second lateral member is present at the second end of the center portion and is perpendicular thereto.

### FIELD OF THE INVENTION

The present invention relates generally to vehicle wheel accessories, more specifically but not by way of limitation, a mud control device that is mounted within a wheel of a vehicle proximate the brake calipers, wherein the present invention provides removal of mud present on the wheel rim so as to substantially inhibit mud from contacting the brake pads and calipers of the vehicle.

### BACKGROUND

Brake calipers are a critical component of a vehicle's braking system, serving the vital function of clamping down on the brake pads to create friction and halt the vehicle’s motion. While the primary focus in automotive maintenance often revolves around engine performance and tire condition, the cleanliness of brake calipers is equally important, particularly in off-road conditions or regions prone to mud and debris. This essay will discuss the significance of keeping mud off brake calipers, focusing on safety, performance, and maintenance longevity. Brake calipers must operate efficiently to ensure that the vehicle can stop promptly and effectively. When mud accumulates on or around the calipers, it can impede their functionality. Mud can interfere with the movement of the caliper pistons, leading to uneven braking and decreased responsiveness. This can result in longer stopping distances, which is particularly dangerous in emergency situations where rapid deceleration is required. Furthermore, excessive buildup of mud can lead to brake fade, where the brakes become less effective due to overheating. Ensuring that brake calipers remain clean and free from debris is essential for maintaining optimal braking performance and, consequently, the safety of all road users.

In addition to safety concerns, the presence of mud on brake calipers can significantly affect the overall performance of the braking system. Brake calipers are designed to exert a specific amount of force on the brake pads. When mud interferes with this mechanism, it can lead to inconsistent braking performance. For instance, a dirty caliper may not apply even pressure across the brake pad, resulting in uneven wear and potential damage to both the pads and the rotors. This not only diminishes the effectiveness of the brakes but can also lead to costly repairs and replacements over time. Regularly cleaning the brake calipers and ensuring they are free from mud enhances their performance, ensuring that they function as intended and provide reliable stopping power. Regular maintenance of a vehicle’s braking system is crucial for its longevity and reliability. Keeping mud and debris off brake calipers is an integral part of this maintenance routine. Mud can contribute to corrosion and rust formation on the calipers, particularly if the vehicle is exposed to moisture. Corroded calipers are less effective and can lead to more extensive damage, requiring expensive repairs or complete replacements. By routinely inspecting and cleaning brake calipers, vehicle owners can prolong their lifespan and reduce the likelihood of encountering severe brake issues. Vehicle owners, especially those who frequently drive in muddy or off-road conditions, should prioritize the cleanliness of their brake systems. While doing so will ensure safer driving experiences, better performance from their braking systems this cannot always be performed as regularly as it should be done.

Accordingly, there is a need for a mud control device that can be operably coupled within the wheel rim of a vehicle wherein the device of the present invention inhibits mud from contacting the brake pads and calipers of the vehicle.

### SUMMARY OF THE INVENTION

It is the object of the present invention to provide a mud control device for a vehicle configured to inhibit mud from contacting the brake calipers and pads wherein the present invention includes a body manufactured from a rigid material such as but not limited to metal.

Another object of the present invention is to provide a device operable to substantially inhibit mud from contacting the brakes of a vehicle wheel wherein the body includes a center portion having a first end and a second end.

A further object of the present invention is to provide a mud control device for a vehicle configured to inhibit mud from contacting the brake calipers and pads wherein the center portion has a first lateral member formed at the first end of the center portion.

Yet a further object of the present invention is to provide a device operable to substantially inhibit mud from contacting the brakes of a vehicle wheel wherein the center portion has a second lateral member formed at the second end of the center portion.

Still another object of the present invention is to provide a mud control device for a vehicle configured to inhibit mud from contacting the brake calipers and pads wherein the center portion includes a first longitudinal edge that is arcuate in form.

An additional object of the present invention is to provide a device operable to substantially inhibit mud from contacting the brakes of a vehicle wheel wherein the center portion includes a second longitudinal edge that is straight in form.

Yet a further object of the present invention is to provide a mud control device for a vehicle configured to inhibit mud from contacting the brake calipers and pads wherein the second longitudinal edge is proximate the inner surface of a wheel rim ensuing installation of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side perspective view of the present invention installed on an exemplary vehicle wheel; and

FIG. 2 is a bottom perspective view of the present invention; and

FIG. 3 is a perspective view of the present invention installed on an exemplary vehicle wheel; and

FIG. 4 is a bottom perspective view of the present invention.

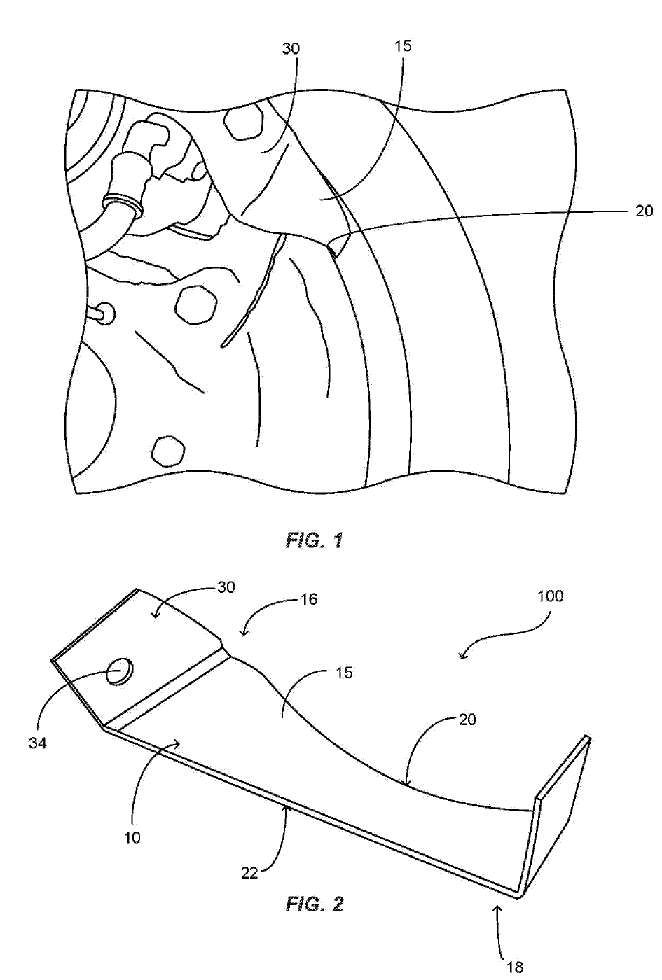

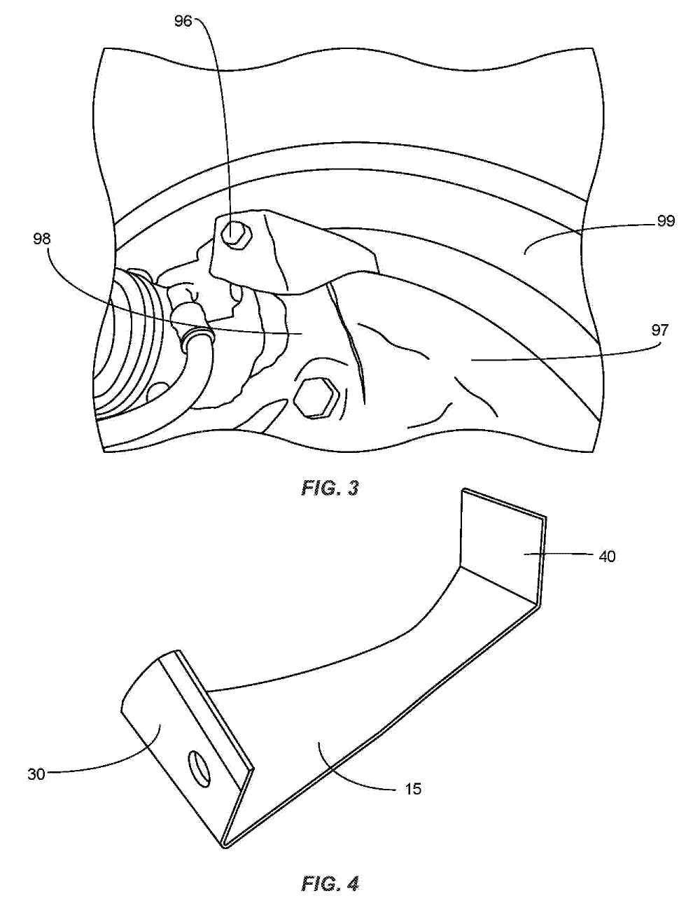

### DETAILED DESCRIPTION

Referring now to the drawings submitted herewith, wherein various elements depicted therein are not necessarily drawn to scale and wherein through the views and figures like elements are referenced with identical reference numerals, there is illustrated a mud control device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the mud control device 100 in configured to be installed over the brake calipers 98 of a vehicle wheel 99 so as to substantially inhibit mud and debris from contacting the brake calipers 98 and as such maintain the brake pads free from debris. It should be understood within the scope of the present invention that the mud control device 100 can be manufactured from a durable rigid material such as but not limited to aluminum. Furthermore, it is contemplated within the scope of the present invention that the body 10 could be manufactured in alternate sizes to accommodate different sizes of vehicle wheels.

The mud control device 100 includes body 10 wherein the body 10 includes a center portion 15. The center portion 15 includes a first end 16 and a second end 18. The center portion 15 is planar in form having a thickness of no more than one-quarter of an inch. The center portion 15 has a first longitudinal edge 20 and a second longitudinal edge 22 on opposing sides of the center portion 15. The first longitudinal edge 20 extends intermediate the first end 16 and second end 18. First longitudinal edge 20 is arcuate in form so as to extend over the wheel disc 97. The arcuate shape provides improved coverage of the brake calipers 98 and avoids interference with the wheel disc 97. Located on the opposing side of the body 10 is the second longitudinal edge 22. The second longitudinal edge 22 extends intermediate the first end 16 and second end 18 and straight in form. The form of the second longitudinal edge 22 allows the placement thereof adjacent the inner surface of the vehicle wheel 99 so as to remove any mud and debris present thereon prior to reaching the brake calipers 98.

The body 10 includes a first lateral member 30 formed at the first end 16 of the center portion 15. The first lateral member 30 is contiguous with the center portion 15 and is perpendicular thereto. First lateral member 30 further includes an aperture 34 wherein the aperture 34 is configured to have fastener 96 journaled therethrough for mounting of the mud control device 100. Contiguously formed with the center portion 15 at the second end 18 thereof is the second lateral member 40. The second lateral member 40 is similarly sized and shaped as the first lateral member 30 and is perpendicular to the center portion 15. The shape of the body 10 provided by the orientation of the first lateral member 30 and second lateral member 40 substantially inhibits any mud and debris from being able to contact the brake calipers 98. It is contemplated within the scope of the present invention that the first lateral member 30 and second lateral member 40 could be provided in alternate shapes and sizes in order to achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A mud control device that is configured to substantially inhibit mud and debris from contacting brake system components adjacent a vehicle wheel wherein the mud control device comprises:
a body, said body having a center portion, said center portion being planar in manner having a first end and a second end, said center portion having a first longitudinal edge and a second longitudinal edge, said body further having a first lateral member, said first lateral member being contiguous with said center portion at said first end thereof, said first lateral member being perpendicular to said center portion, said body further including a second lateral member, said second lateral member being contiguous with said center portion at said second end thereof, said second lateral member being perpendicular to said center portion; and
wherein said body is mounted adjacent a brake caliper so as to position said second longitudinal edge adjacent an inner surface of the vehicle wheel positioning said body in front of the brake caliper so as to substantially inhibit mud and debris from contacting the brake caliper.

2. The mud control device as recited in claim 1, wherein said first longitudinal edge is arcuate in form.

3. The mud control device as recited in claim 2, wherein said second longitudinal edge is straight in form.

4. The mud control device as recited in claim 3, wherein said first lateral member further includes an aperture formed therein, said aperture configured to have a fastener journaled therethrough.

5. The mud control device as recited in claim 4, wherein said body is manufactured from metal.
